(19) United States
(12) Patent Application Publication
(10) Pub. No.: US 2010/0036570 A1
(43) Pub. Date: Feb. 11, 2010

(54) METHOD FOR ASSURING SYNCHRONIZATION BETWEEN AN ENGINE CONTROLLER AND A TRANSMISSION CONTROLLER AND COMPUTER PROGRAM AND PRODUCT

(76) Inventors: Peter Templin, Vastra Frolunda (SE); Daniel Johansson, Goteborg (SE); Anders Ekdahl, Goteborg (SE)

Correspondence Address: WRB-IP LLP, 1217 KING STREET, ALEXANDRIA, VA, 22314, US

(21) Appl. No.: 12/441,389

(22) PCT Filed: Sep. 11, 2007
(86) PCT No.: PCT/SE2007/000789

§ 371 Date: Jun. 15, 2009

Related U.S. Application Data
(60) Provisional application No. 60/825,866, filed on Sep. 15, 2006.

(51) Int. Cl. G06F 19/00

(52) U.S. Cl. 701/54; 701/102

(57) ABSTRACT

Method and arrangement for assuring synchronization between an engine controller and a transmission controller on a heavy vehicle with an automatic mechanical transmission with respect to maximum allowable engine torque output levels. The engine controller is programmed to automatically communicate existing programmed maximum allowable engine torque capacities to the transmission controller under all, or predetermined circumstances in order to assure synchronous performance between the engine and transmission when executing program routines that depend upon program agreement existing between the two controllers in order to properly affect desired performance in the vehicle.

### BACKGROUND AND SUMMARY

The present invention generally relates to synchronization of maximum engine torque levels between the engine control unit and the transmission control unit to adapt the gear selection and shifting strategies in the transmission control unit.

The present invention also relates to a computer program and computer program product both to be used with a computer for executing said method.

Heavy commercial vehicles such as overland trucks and buses are known to employ automatic mechanical transmissions (AMTs) that are based on preprogrammed routines. These transmissions generally have been arranged to provide uniform characteristics based upon the preprogrammed routines. Engines have been controlled by electronic controls for a number of years as well. However, the communication of certain information between the engine control unit and the transmission control unit has heretofore been lacking. Thus, the engine control unit might have one set of stored criteria while the transmission might have another, and thereby causing inconsistent performance.

One particular example of information that typically has not been shared is changes to engine torque level restrictions. Engines are often capable of producing torque on the order of 2000 Nm and transmissions are capable of having gear ratios of around nineteen- to-one (19:1). This provides a capability for increasing the torque being supplied to the drive train of the vehicle by a similar factor. The rear axle and other components of the drive train often are not capable of with standing such high torque levels which can be as high as 38,000 Nm, or greater.

In order to prevent excessive torque levels in the driveline, the engine can be programmed with maximum allowable torque limits for a particular set of gears. This setting prevents the engine from sending too much torque to the drive train. While one engine torque level is the norm, multiple torque level settings can be established so that a maximum manageable torque is delivered to the drive train for a given series of gears. These various maximum torque settings are normally based on the amount of torque that the weakest member of the drive train can withstand; i.e. the “weakest link in the chain theory”. In the instance where the rear axle is the weakest member, the torque produced by the engine can be limited to that amount which the rear axle can bear. Thus, a desirable maximum engine torque can be determined for each particular gear ratio in the transmission.

Effecting a maximum engine torque for each gear, when engaged, becomes a burdensome and complex task. Therefore, maximum engine torque limits have been traditionally established for groups of gear ratios thereby creating “bands” of maximum engine torque where each band applies to a number of sequential gears. For example, three sets of maximum engine torque bands can be provided. These bands can be correlated to a low gear ratio, a mid-level gear ratio, and a high gear ratio. Thus, the maximum engine torque at any particular time depends on which gear ratio group (low, medium or high) the presently engaged gear belongs. These settings are typically installed on the transmission controller and engine at the time of manufacture.

However, in the situation in which the engine is upgraded or downgraded in the future, the information concerning the appropriate torque levels is almost uniformly not communicated to the transmission controller, but only the engine controller. In a typical case, a heavy truck is resold after fleet use in which conservative limitations have been placed on the engine's performance. The new owner, however, desires greater performance and therefore the engine controller is reprogrammed to permit greater power outputs, which translates to greater torque outputs to the transmission, as well. As a result, the torque outputs have increased for each of the “gear bands”, but the transmission controller, which has not been updated with corresponding changes, expects the old torque levels and acts accordingly. This translates into inconsistencies in performance because the two controllers (engine and transmission) are now working based on two different programmed criteria without “knowing” it. Thus, there is a need to share the updated information from the engine control unit to the transmission control unit regarding the allowable torque limits for a particular set of gears and thereby assure that the criteria being applied by the engine controller is synchronized with the criteria being applied by the transmission controller.

In at least one embodiment, an aspect of the present invention takes the form of a method for assuring synchronization between an engine controller and a transmission controller on a heavy vehicle with respect to maximum allowable engine torque output levels. In a preferred embodiment, the vehicle is equipped with an automatic mechanical transmission. To assure synchronization, the engine controller is programmed to automatically communicate existing programmed maximum allowable engine torque capacities to the transmission controller under all, or predetermined circumstances. In this way, synchronous performance is assured between the engine and transmission when executing program routines that depend upon program agreement existing between the two controllers in order to properly affect desired performance in the vehicle.

### BRIEF DESCRIPTION OF THE DRAWINGS

The accompanying drawings variously illustrate aspects of the presently disclosed inventions. It should be appreciated that the illustrated embodiments are exemplary only, and do not serve as limitations to the protection. The drawings do, however, constitute part of the disclosure of the specification, and thereby contribute to, and provide support for the patented inventions. In the figures:

FIG. 1 is a schematic representation of a vehicle equipped with an internal combustion engine, automatic mechanical transmission and emission control device;

FIG. 2 is a diagram showing different torque limitation levels placed on the engine based upon selected gear bands; and

FIG. 3 is an alternate diagram illustrating a different configuration for similar torque limitation impositions placed on the engine based upon selected gear bands.

FIG. 4 shows the invention applied on a computer arrangement.

### DETAILED DESCRIPTION

The present invention presents method and apparatus for efficient and thorough communication of information between the engine control unit and transmission control unit regarding the maximum allowable torque produced by the engine for a specific range of gear ratios. Since the amount of torque transmitted in the drive train can be magnified by the gear ratio currently engaged in the transmission, the maximum allowable engine torque must be restricted to ensure that the torque experienced in the drive train does not exceed allowable limits.

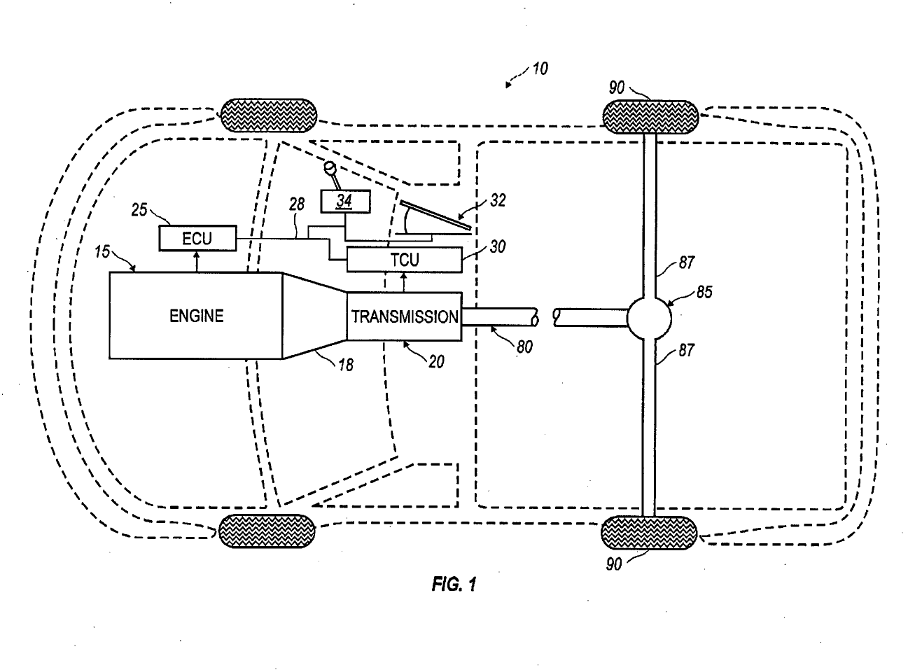

In at least one embodiment and as generally illustrated in FIG. 1, the invention takes the form of a heavy vehicle 10, such as truck, powered by an internal combustion engine 15. The internal combustion engine 15 is coupled to transmission 20 via a clutch 18. Preferably, this clutch 18 is a friction clutch 18 that can be automated in order to control engagement and disengagement of the transmission 20. The transmission 20 is connected to the drivewheels 90 of the vehicle 10 by a driveshaft 80, differential gear 85, and rear axles 87.

An engine control unit 25 is adapted for controlling the engine 15 and is in communication with the transmission control unit 30 that is adapted for controlling the transmission 20. Exemplarily, the inter-controller communication is affected across an existing data bus 28 (typically referred to as the CAN bus). While the description herein makes reference to a specific controller, the various control commands may be implemented on one or the other control unit. Furthermore, it is possible to combine both the engine control unit 25 and transmission control unit 30 into a single control unit. Additionally, it is further possible to have the engine control unit 25 and transmission control unit 30 composed of several control units, such as gear shifting control unit and gear selection control unit replacing the transmission control unit 30 and communicating therebetween.

An accelerator pedal 32 and a gear selector 34 are further provided to allow the driver to instruct the engine control unit 25 as well as the transmission control unit 30. The gear selector 34 preferably has positions for manual shifting, automatic shifting, low gears, and reverse. Other gear selections are also considered within the scope of this disclosure; those above are given as examples of possible gear selections.

When the engine 15 produces a given amount of torque, the transmission 20 magnifies the amount of torque produced by the engine 15. As explained above, the low gear of an automatic mechanical transmission 20 can produce a ratio of as much as approximately 19:1 such that for every 19 rotations of the engine 15 only one rotation of the transmission's output shaft is achieved. While the speed at which the output shaft rotates is reduced, the available torque output from the shaft is roughly multiplied by a similar factor; i.e., 19 times. In this regard, a typical internal combustion engine 15 might be capable of producing about 2,000 Nm of torque. Thus, the torque available at the output shaft of the transmission 20, if engine 15 is allowed to reach its maximum power level, would be 38,000 Nm. Most components in the drive train are not rated for this high of a torque level. For example, the rear axle 87 might only be rated to 9,500 Nm. Thus, the torque produced by the engine 15 should be limited to 500 Nm (9500÷19=500). This is provided by way of example only, and those persons skill in the art will appreciate how similar limitations would be calculated and applied.

Furthermore, the ratings of the axle components might be higher for short duration loads as compared to longer duration load modes. Thus when changing gears rapidly such as starting a vehicle 10 from a stop, the allowable torque load for the axle 87 might be 14,000 Nm. When a vehicle is rapidly moving through lower gears, the torque level being transmitted to the rear axle 87 or other components of the drive train can be higher than when the components are experiencing the load for extended periods of time such as driving with the particular gear engaged. The solutions presented herein are focused generally on the limitations where the torque being supplied by the engine 15 is over a longer period of time. However, where it is desirable, similar limits can be applied to other torque ratings of the components in the drive train.

FIG. 2 illustrates a series of typical torque vs. engine speed curves for an internal combustion engine 15, preferably a diesel engine. The upper line 105 represents the maximum torque that the engine 15 is capable of producing. Thus, when the engine 15 is appropriately fueled it will not exceed this amount. The level of torque L3 produced by the engine 15 in the example is 2,000 Nm, but could be other torque levels depending on the particular engine 15. However, when the drive train is not capable of receiving torque above a certain predetermined limit, restrictions must be placed on the engine 15 to prevent the experienced torque in those particular elements from being exceeded.

In order to allow an appropriate use of the power from the engine 15, bands of maximum allowable torque can be established as described above. For example, a transmission 20 with twelve gears might be divided into three bands as follows. The first band would be for low gears typically gears 1, 2 and 3. The ratio of these gears could be 19.0, 14.0 and 11.5, respectively. Likewise, a second band of mid-range gears could be 4, 5 and 6 with gear ratios of 9.0, 7.0 and 5.5, respectively. Finally the high gears would be enabled to operate at the maximum engine torque level; these gears have gear ratios less than approximately 5.00. Using the above gear ratios as an example, the first band would impose a requirement that the engine 15 be limited to an output of maximum 500 Nm.

As previously mentioned the maximum available torque from the engine 15 is shown by L3 in FIG. 2. When the axle 87 is rated above the maximum torque the engine 15 can produce multiplied by the transmission gear ratio, then the maximum torque produced by the engine 15 can be used. The first band described above is for use with low gears. While large amounts of torque are desired in these gears, the amount of torque produced by the engine 15 does not need to be as large because of the multiplication factor applied by the transmission 20. Thus, the amount of torque produced by the engine 15 should be limited according to line 115 with a maximum torque produced by the engine 15 signified by L1. Similarly, the mid-range gears require that the torque being produced by the engine 15 not exceed the level signified by L2 and described by line 110. Depending on the application, the torque levels set forth above may be changed to account for an increased need in maximizing torque for particular gears. In some embodiments, a specialized torque curve could be established on a per gear basis. The number of specialized band is determined by the application and can be programmed into the engine controller 25 as desired.

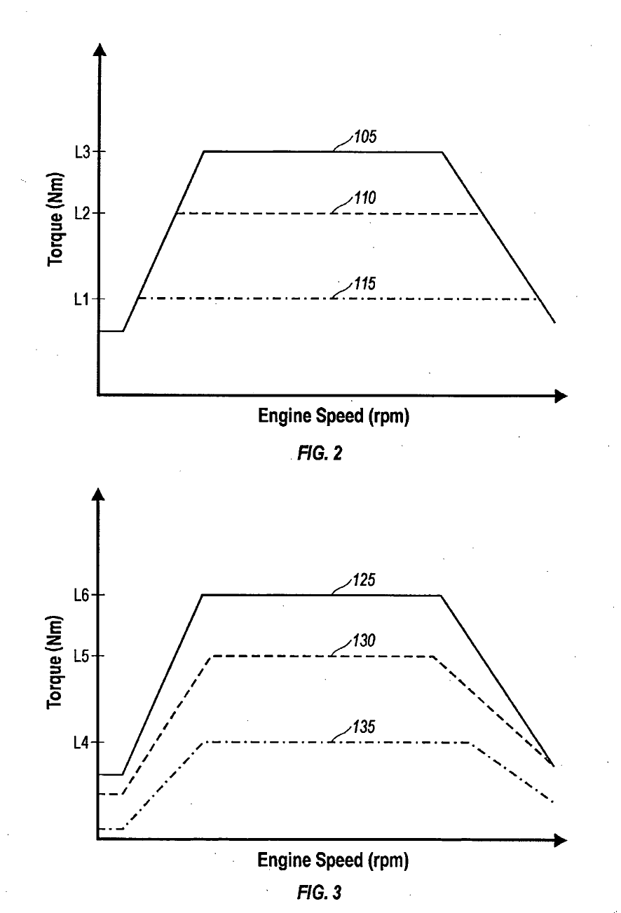

In another embodiment, the engine 15 could be programmed to produce the alternative torque curves as shown in FIG. 3 based on reduced-scale curves for the lower torque limits. The maximum engine torque curve 125 is similar to that shown in FIG. 2 and the maximum torque produced by the engine is signified by L6. Similar to the torque limits shown in FIG. 2, a maximum torque limit for the low gears is signified by line 135 with a maximum of torque of L4. Likewise, the mid-range gear torque limitation is described by line 130 with a maximum torque of L5. However, the torque limitations, of FIG. 3, are offset from the maximum engine torque lines compared to the maximum limitations set forth in FIG. 2. Thus, the torque being produced by the engine in FIG. 3 for the mid-range and low-range gears is always less than the torque the engine is capable of producing. The torque limitation according to FIG. 2 follows the standard engine torque curve 105 until it reaches the predetermined maximum limit. This can also be described as having a torque ceiling on the torque produced by the engine. These torque limitations presented in FIGS. 2 and 3 are given as examples of possible limitations that could be imposed on the engine and one skilled in the art would appreciate other ways of implementing the torque limitations.

An automatic mechanical transmission control unit 30 is capable of selecting a particular gear ratio based upon operating conditions of the vehicle 10 including the torque being produced by the engine 15. When making gear shifts, the transmission controller 30 communicates to the engine 15 the desired fueling for the particular gear shift. However, the torque limitations imposed on the engine 15 by the engine controller 25 can prevent the transmission controller 30 from correctly selecting the appropriate gear to be engaged. When the transmission controller 30 knows of the limitations imposed on the engine 15 by the torque limitations, then an appropriate gear can be selected to provide the correct amount of torque to the drivewheels 90 of the vehicle 10.

When installed by the original manufacturer, the transmission controller 30 and engine controller 25 normally will be programmed with the same maximum engine torque limits on a band-wise basis. However, as described above, engine torque capabilities might be adjusted, for instance when changing ownership via reprogramming of the engine controller 25.

When changing the engine programming to affect different engine performance characteristics, the torque output from the engine 15 is also typically changed. However, the transmission controller 30 might not be “aware” of the change and request fueling of the engine 15 according to the previously stored values in the transmission controller 30. This can lead to a situation in which the engine 15 supplies more torque than the system is designed to handle or does not supply enough torque.

For example, when a heavy vehicle 10 is climbing a hill, low gears are utilized at high torque values. In some circumstances, the initiation of an upshift of the transmission 20 is not possible because of the limitation placed on the engine 15 according to the torque limitations. If the transmission 20 is not aware of the torque limitation, it will assume that the torque limitation is the maximum torque the engine 15 could produce. Using the above example in regards to low gears, if the transmission 20 was currently engaged in gear 2 and the transmission 20 initiated an upshift, the available torque at the wheels 90 when the engine 15 was at maximum torque capacity would drop from 7000 Nm to 5750 Nm. Supposing that the torque required at the wheels 90 was 6000 Nm, this upshift would result in a problem while climbing the hill. If there was not a torque limitation, the implementation of the upshift would not result in a problem because 23,000 Nm would be available at the drivewheels 90. Thus without “knowledge” of the newly programmed engine torque limitations, the transmission controller 30 will make the wrong gear selection. If the transmission controller 30 had been reprogrammed with the information regarding the new torque limitations, the transmission 20 would remain in gear 2 without attempting an upshift.

Referring back to FIG. 1, the communication link 28 shown between the transmission controller 30 and the engine controller 25 can be used to transfer data bi-directionally between the two controllers 25, 30. This data bus 28 can be the CAN bus on the heavy vehicle 10 or a specialized communication link between the two controllers 25, 30. In a preferred embodiment of the present invention, a specialized communication routine is programmed into the engine controller 25 such that when the engine controller 25 receives an update regarding engine torque limitations, this information is shared with the transmission controller 30. Alternatively, a port on the data bus 28 can be used to transfer the new torque limitations to the engine controller 25 and thereby simultaneously supply the information to the transmission controller 30.

Additionally when the engine controller 25 receives an update regarding the torque limitations imposed, it can transmit these new torque limitations to the transmission controller 30 at the next vehicle start-up time. Thus, the information regarding the torque limitations can be pushed to the transmission controller 30 at start-up if the torque limitations have changed since the last start up. Alternatively, the engine controller 25 can be programmed such that when an update is received by the engine controller 25, that information is pushed to the transmission controller 30.

The above described communication routine can be implemented to share information between the engine controller 25 and transmission controller 30 in regards to other data that is useful for the transmission controller 30 to have in order to more efficiently achieve its task. One example is where the engine 15 is upgraded to have new injectors that increase response time or horsepower available from the engine 15. If a quicker response time is available from the engine 15, the transmission controller 30 can use this information to perform quicker shifts as well. Likewise, if the engine 15 is outfitted with a turbocharger, the engine characteristics can change. If the transmission controller 30 knows of this change, it can adapt the gear shifting and selection routines in light of this upgrade. If an after-treatment system is added or upgraded, then the transmission controller 30 can utilize special routines for the after-treatment system. While these are provided as examples, one skilled in the art would appreciate additional systems that could be so installed on the system and information regarding the change would be desired by the transmission control routines.

While the above has been described generally as relating to upgrading/changing certain features or parts associated with the engine 15, the communication routine could equally apply at the original manufacture state. This would insure the manufacturer that the information is going to be appropriately shared by the engine control unit 25 and the transmission control unit 30 at all times. Likewise, the information first received by the transmission control unit 30 could be communicated to the engine control unit 25 using a similar routine.

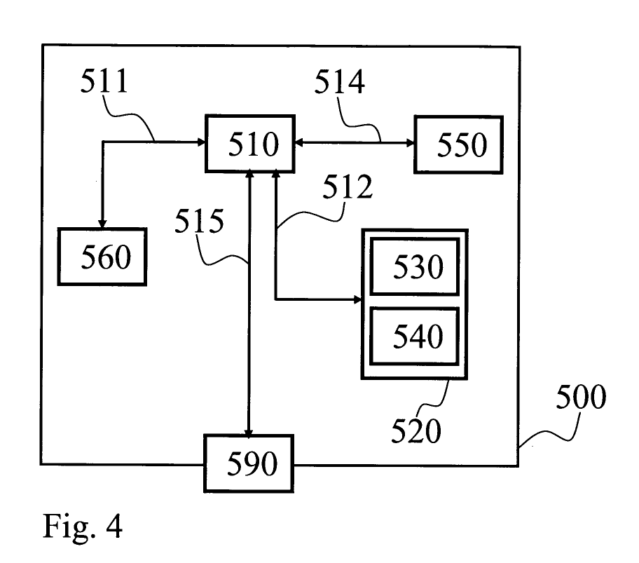

FIG. 4 shows an apparatus 500 according to one embodiment of the invention, comprising a nonvolatile memory 520, a processor 510 and a read and write memory 560. The memory 520 has a first memory part 530, in which a computer program for controlling the apparatus 500 is stored. The computer program in the memory part 530 for controlling the apparatus 500 can be an operating system.

The apparatus 500 can be enclosed in, for example, a control unit, such as the controller 25 or 30. The data-processing unit 510 can comprise, for example, a microcomputer.

The memory 520 also has a second memory part 540, in which a program for assuring synchronization between an engine controller and a transmission controller according to the invention is stored. In an alternative embodiment, the program for assuring synchronization between an engine controller and a transmission controller is stored in a separate nonvolatile data storage medium 550, such as, for example, a CD or an exchangeable semiconductor memory. The program can be stored in an executable form or in a compressed state.

When it is stated below that the data-processing unit 510 runs a specific function, it should be clear that the data-processing unit 510 is running a specific part of the program stored in the memory 540 or a specific part of the program stored in the nonvolatile recording medium 550.

The data-processing unit 510 is tailored for communication with the memory 550 through a data bus 514. The data-processing unit 510 is also tailored for communication with the memory 520 through a data bus 512. In addition, the data-processing unit 510 is tailored for communication with the memory 560 through a data bus 511. The data-processing unit 510 is also tailored for communication with a data port 590 by the use of a data bus 515.

The method according to the present invention can be executed by the data-processing unit 510, by the data-processing unit 510 running the program stored in the memory 540 or the program stored in the nonvolatile recording medium 550.

The invention should not be deemed to be limited to the embodiments described above, but rather a number of further variants and modifications are conceivable within the scope of the following patent claims.

1. A method for assuring synchronization between an engine controller and a transmission controller on a heavy vehicle, equipped with an automatic mechanical transmission, with respect to maximum allowable engine torque output levels, the method comprising: programming the engine controller to automatically communicate existing programmed maximum allowable engine torque capacities to the transmission controller thereby assuring synchronous performance between the engine and transmission when executing program routines that depend upon program agreement existing between the two controllers in order to properly affect desired performance in the vehicle.

2. A method as in claim 1, wherein a specialized communication routine is programmed into the engine controller such that when the engine controller receives an update regarding engine torque limitations, this information is shared with the transmission controller.

3. A method as in claim 1, wherein when the engine controller receives an update regarding the torque limitations imposed, it transmits these new torque limitations to the transmission controller at the next vehicle start-up time.

4. A computer program comprising a program code for executing the method as claimed in claim 1, when the computer program is executed on a computer.

5. A computer program product comprising a program code, stored on a computer-readable medium, for executing the method as claimed in claim 1, when the computer program is executed on the computer.

6. A computer program product directly loadable into an internal memory in a computer, which computer program product comprises a computer program for executing the method as claimed in claim 1, when the computer program on the computer program product is executed on the computer.
